(19) United States
(12) Patent Application Publication
(10) Pub. No.: US 2025/0095196 A1
(43) Pub. Date: Mar. 20, 2025

(54) FINDING DISPOSITION OF AN OBJECT

(71) Applicant: VIRTEK VISION INTERNATIONAL INC, Waterloo (CA)

(72) Inventors: Ahmed Elhossini, Waterloo (CA); Mehrdad Bakhtiari, Kitchener (CA)

(73) Assignee: VIRTEK VISION INTERNATIONAL INC, Waterloo (CA)

(21) Appl. No.: 18/890,592

(22) Filed: Sep. 19, 2024

Related U.S. Application Data
(60) Provisional application No. 63/539,476, filed on Sep. 20, 2023.

(51) Int. Cl. G06T 7/73; G01B 11/00; G01B 11/26; G06T 7/246

(52) U.S. Cl. CPC G06T 7/73; G01B 11/002; G01B 11/26; G06T 7/248; G06T 2207/10016

(57) ABSTRACT

A system for determining geometric disposition of an object within a coordinate system includes a processor and a sensor array. The sensor array includes a plurality of sensors oriented to scan a first edge and a second edge of an object for identifying a disposition of the first edge and the second edge within a coordinate system. The sensor array is electronically connected to the processor for signaling the identified disposition of the first edge and the second edge of the object within the coordinate system. The processor is programmed to calculate a location of an intersecting point of the first edge and the second edge. The processor calculates disposition of the object within the coordinate system from the calculated location of the of the intersecting point.

### PRIOR APPLICATIONS

The present application claims priority to U.S. Provisional Patent Application No. 63/539,476 filed on Sep. 20, 2023, the contents of which are included herein in entirety.

### TECHNICAL FIELD

The present application relates generally toward finding a disposition of an object within a coordinate system. More specifically, the present application relates toward implementation of sensors to accurately identify location of an object within the coordinate system for use with machine inspection of objects.

### BACKGROUND

Increasing the use of automation, and more specifically sensor technology to develop spatial recognition of an object within a coordinate system is intended to improve manufacturing efficiency, particularly with respect to inspection of objects. Rigid objects are particularly suited for inspection using various types of sensors. In order to inspect assembly of components to a work surface of an object to verify assembly accuracy, the disposition of the object within a coordinate system of an inspection system should be estimated using a tool or set of tools. Previous inspection tools include digital cameras that make use of CCD and CMOS sensor arrays. Additional sensors capable of identifying geometric features can augment the object disposition estimation within the defined coordinate system. These include laser sensors, lidar technology, radar technology and the like, each of which may identify distance of a surface from the sensor.

Inspection tools such as these are quite useful when identifying disposition of an object, and particularly a stationary rigid body or an object that remains stationary during inspection and requires a single scan with the inspection tool. However, when the rigid body or object passes through the inspection system (i.e. moving object) additional steps are required. First, detection of the presence of the object within the inspection area is performed, including obtaining the initial disposition or orientation of the rigid body surface at the beginning of any inspection process. Secondly, the rigid body must be tracked to identify changes in its disposition or location over time to ensure an accurate inspection.

Therefore, it is desirable for an inspection system to be able to accurately estimate the initial disposition of the object being inspected as part of an inspection process. An inspection surface that requires inspection defines corners and edges that establish a periphery of the surface. Inspection of components that are attached to the work surface during an assembly process or other performed work such as, for example milling or machining contours or apertures is often necessary. It is particularly necessary to determine initial disposition of the work surface within a coordinate system to for the inspection to be conducted in an accurate and timely manner. For example, once the object being inspected is located within a defined coordinate system, inspection of a work or assembly process may be initiated. Often this requires the use of expensive and difficult to handle fixtures. These fixtures often do not provide the accuracy for performing an inspection. Furthermore, movement of the object being inspected may require the inspection process to be repeated. Therefore, it would be desirable to provide an automated system that accurately locates an object to be inspected within a defined coordinate system.

### SUMMARY

A system for determining geometric disposition of an object within a coordinate system includes a processor and a sensor array. The sensor array includes a plurality of sensors oriented to scan a first edge and a second edge of an object for identifying a disposition of the first edge and the second edge within a coordinate system. The sensor array is electronically connected to the processor for signaling the identified disposition of the first edge and the second edge of the object within the coordinate system. The processor is programmed to calculate a location of an intersecting point of the first edge and the second edge. The processor calculates disposition of the object within the coordinate system from the calculated location of the of the intersecting point.

Estimation of the initial disposition and continuously estimating the disposition after defined or dynamic movement of an object within a defined coordinate system improves the speed and the accuracy of an inspection process. Determination of an intersecting point of a first edge and a second edge of the object and defining the intersecting point as an object datum and locating the datum with the defined coordinate system enables the object to be tracked through dynamic or defined movement through an inspection cell in an accurate and rapid rate enables inspection of the object in a manner not previously thought practicable.

### BRIEF DESCRIPTION OF THE DRAWINGS

Other advantages of the present invention will be readily appreciated as the same becomes better understood by reference to the following detailed description, when considered in connection with the accompanying drawing, wherein:

FIG. 1 shows a typical inspection surface with affixed components;

FIG. 2 shows a graphic representation of corner detection;

FIG. 3 shows a schematic of detection system of the present application;

FIG. 4 shows a schematic of an alternate embodiment of the invention of the present application implementing a multi sensor array; and

FIG. 5 shows a further schematic of the alternate embodiment of the invention of the present application representing an object in motion.

### DETAILED DESCRIPTION

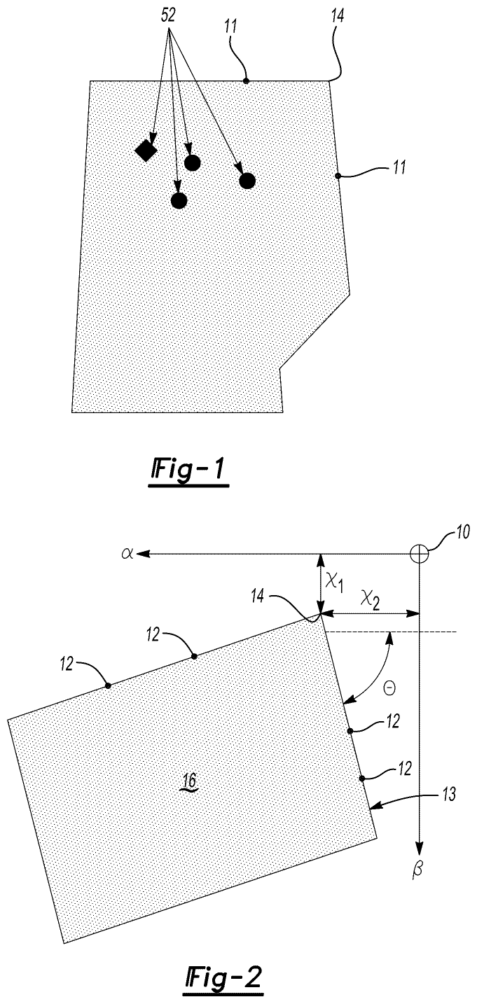

Referring now to FIG. 1, the scientific principles of the invention of the present application will now be explained. A disposition of an inspection surface within any given plane may be determined in two dimensions, i.e., within a two-dimensional coordinate system. Correlation or registration of a known point or datum on the inspection surface within an inspection tool's coordinate system is determined by the orientation of the inspection surface within a common coordinate system defined between an inspection tool, i.e., sensors, cameras and the like, and the inspection surface. It should be understood that reference to “inspection surface” within this application is made with respect to the rigid body surface of an object, but also includes a semi-rigid body surface that is dimensionally stable.

When the shape of the rigid inspection surface takes the form of a Polygon, any vertices of the Polygon can be used as a known point to find the initial disposition of that surface within the common coordinate system. However, it should be understood that the overall shape of an inspection surface may include arcuate and nonlinear edges. It is desirable that at least two intersecting edges of the inspection surface are linear and form a portion of a polygon for the inspection method of the present invention to be implemented. In this instance, a corner or intersection of the linear edges establish a datum by estimation of the intersection or intersecting point of the neighboring linear edges. Identifying the intersecting point as a datum as part of a computer aided design (CAD) that adopts standard General Dimensioning & Tolerancing (GD&T) principles enables precise registration of the object with the desired coordinate system.

Referring now to FIG. 2, an inspection tool 10 is provided a view of a first edge 11 and a second edge 13. In this embodiment, the inspection tool 10 is a camera and defines a coordinate system defining at least two axes a and b. A disposition of each edge 11, 13 is estimated by each edges constructing points 12 from which an intersecting point 14 is also estimated. A rigid construct of an inspection surface 16 enables use of the constructing points 12 for determination of disposition of the inspection surface 16 as will be explained further herein below. In this non-limiting example, the inspection surface 16 is shaped in the form of a Polygon. Any vertices define by the Polygon maybe used as a known point to find initial disposition of the surface within the common coordinate system of with the inspection tool 10. Thus, the location of a corner defined by the inspection surface 16 may be used as a datum defined by the GD&T scheme is estimated as the intersection of neighboring edges 11, 13 of the inspection surface 16 if the edges are substantially linear.

The location and orientation of each edge 11,13 is obtained through identifying and locating at least two constructing points 12 on each edge. identifying and locating more than two constructing points improves the estimation accuracy for any edge 11,13. Identified constructing points 12 on each edge 11,13 is easily estimated using different tools including linear distance sensors 42 (FIG. 4), optical representation of the edge captured by a camera 10, point cloud data obtained using lidar or even a depth camera. Each of these devices are within the scope of this invention and may be implemented either individually or in combination thereof.

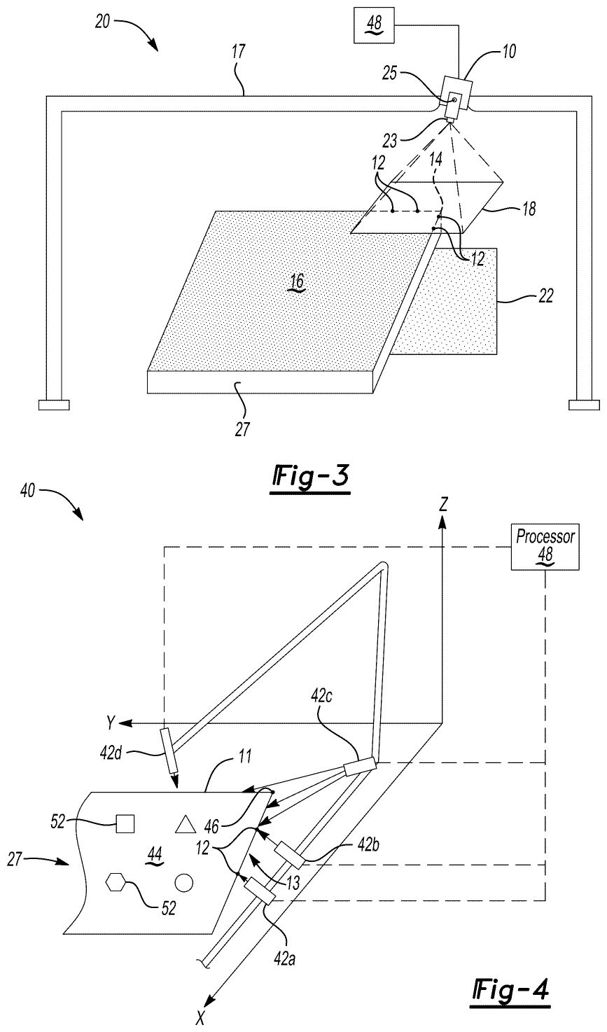

The process for determination of the disposition of a rigid inspection surface is achieved through identifying a known vertices (datum) 14 referred to within this application as “corner detection.” A first embodiment is shown in FIG. 3, in which a schematic of the system to detect the corner 14 of a rigid inspection surface 16 is shown generally at 20. The camera 10 is oriented to face downwardly at a perpendicular orientation to the inspection surface 16. The camera 10 is fixedly attached to a camera frame 17 above the inspection surface 16. The location and orientation of the camera 10 on the frame 17 are selected to ensure that the corner 14 defined by the inspection surface 16 is expected in a field of view 18 of the camera 10 that defines a region of interest. In one embodiment, a black, non-reflective and featureless backdrop 22 is disposed at a location below the inspection surface 16, and more particularly below the field of view 18 in the region of interest. In one embodiment the field of view 18 of the camera 10 does not exceed the size of the backdrop 22 even when the inspection surface 16 is not present. The visible contrast between the inspection surface 16 and the backdrop 22 improves accuracy of the measurements made by the camera 10 when image pixels between different or sequential images are compared.

The camera 10 includes a camera lens 23 and a sensor 25. The sensor is contemplated to be a CCD or a CMOS sensor and constitutes the sensor array as used within the context of this application. As set forth further hereinbelow, the sensor 25 generates image pixels used to determine the disposition of the inspection surface 16 within the defined coordinate system.

To achieve accurate estimation of the disposition of the rigid body surface 16 within the coordinate system by implementing an optical solution, the intrinsic and extrinsic parameters of the camera 10 should be known and predefined. The intrinsic parameters include but are not limited to horizontal and vertical focal lengths, the center of projection, and the lens 23 distortion parameters. The extrinsic parameters include the location and orientation of the camera 10 on the frame 17 within the defined coordinate system.

The process by which the corner 14 of the inspection surface 16 is detected is now explained. A difference image is generated from two successive images or frames generated by the camera 10 to accommodate both situations of stationary and moving object 27 that defines the inspection surface 16 or inspection services 16. A difference image is generated by subtracting pixels of a first image from pixels of a second image. The difference in pixel location between the first image and the second image indicates movement of the inspection surface has occurred.

The difference image is known to present noise even in areas where the object 16 seen within the field of view 18 of the camera 10 has not changed or moved. To reduce noise, a number of Gaussian filters are applied to each image frame. The Gaussian filter is a linear type filter that assists the edge detection by replacing each image pixel with a weighted average of the values of pixels within a rectangle or adjacent region of the image that surrounds the pixel. Application of a Gaussian filter even when a backdrop 22 is present within the field of view 18 improves accuracy of the determination of the disposition of the object 27 within the defined coordinate system.

The difference image, as set forth above, is obtained by subtracting corresponding pixels in two Gaussian filtered images and keeping the absolute values as the determined difference image. In one embodiment, the two Gaussian filtered images are sequential images.

An edge detection algorithm is then applied to the difference image by the processor 48 to extract points on the first edge 11 and the second edge 13 of the inspected surface 16 separately by sweeping the image in the corresponding direction of each edge. By sweeping the image the processor 48 identifies constructing points 12 that align in a linear manner. Thus, constructing points 12 are initially detected on each of the edges 11,13.

From the initially detected constructing points 12, a statistical best fit of a straight line through each set of constructing points defined by each edge is estimated by the computer algorithm run by a processor 48. From this estimation, a statistical best fit axis for each edge is established from the images.

An intersecting point of the best fit lines defined by each of the first edge 11 and the second edge 13 is calculated to define the corner 14 or datum to the inspection surface in the image plane of the camera 10. It should be understood that the image plane in this embodiment is the two dimensional plane perpendicular to the optical axis of the camera 10.

The now identified lines defined by the edges 11,13 that intersect to form the corner 14 or datum are now transformed into the coordinate system defined by the camera 10 or other inspection system using intrinsic and extrinsic parameters. Thus, a common coordinate system is developed between the inspection surface 16 and the camera 10 enabling accurate initial disposition determination within the coordinate system of the inspection surface 16. In this non-limiting embodiment the coordinate system defined by the camera 10 is a two dimensional coordinate system along axes a and b as shown in FIG. 2. Thus, the angular relationship of the lines defined by the constructing points 12 on at least one of the edges 11,13 to at least one of the axes a,b of the defined coordinate system establishes orientation of the object 27 being inspected while the calculated datum (corner) 14 establishes location of the object within the coordinate system.

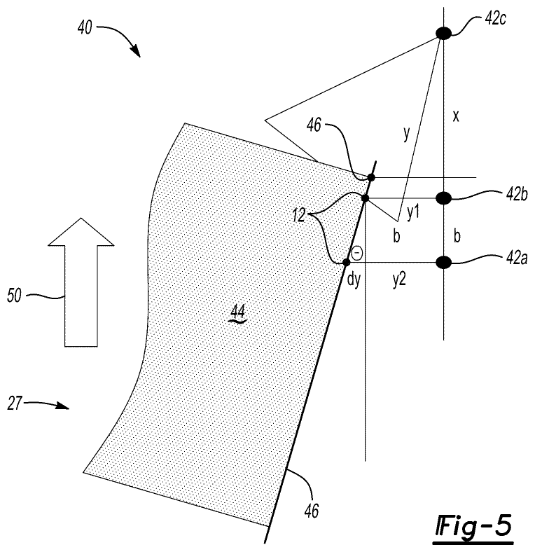

An alternative embodiment is generally shown at 40 in FIGS. 4 and 5. The alternative embodiment maybe performed subsequent to, simultaneous with or independently of the earlier embodiment described hereinabove. The alternative embodiment 40 is used for tracking a moving object 27 with a plurality of cooperative sensors 42. The system 40 includes a processor 48 that calculates an initial disposition of the object 44 from information received from the sensors 42. In addition, the system 40 is also configured to track motion of the object 44 in a three-dimensional space by continuously calculating disposition as identified by the sensors 42. Thus, the system 40 is particularly useful to support automatic inspection of an object even when in motion, whether the motion is directed or dynamic.

The alternative system 40, in one embodiment includes four sensors 42 for sensing in two dimensions. The sensors 42 are configured to sense location of the object 44 to signal the processor 48 to calculate disposition, i.e., location and orientation of the object within the determined coordinate system. Disposition of the object 27 in this embodiment is defined by the location of a datum 46 within a three-dimensional coordinate system (x, y, z coordinates) and its orientation or angle θ to axes defined by the sensors 42. In one embodiment, three sensors 42a, 42b, 42c, are used to measure distance to the object 27 in a specific direction, in this embodiment a horizontal direction. Thus, the sensors 42a, 42b, 42c take the form of linear range sensors. A fourth sensor 42d measures distance in an alternative specific direction, for example, a vertical direction defined by a z axes. Alternatively, the fourth sensor 42d is a range scanning sensor that is used to create a horizontal profile of an edge 411, 13 of the object 44 being inspected. It should be understood that other sensors capable of detecting an edge 11,13 for creating a horizontal profile is within the scope of this invention.

Sensors 42a and 42b are aligned to a horizontal X axis defined by the inspection coordinate system at predetermined, known locations. Sensors 42a and 42b are also positioned in parallel to each other so that sensing orientation is in a common Z plane. Sensors 42a and 42b provide measurement for how far away the object is in the Y direction from the sensors located on the X axis. More specifically, the sensors 42a and 42b measure distance from the X axis to the second edge 13 of the object 44 to be inspected. The distance measurement to the constructing points 12 on the second edge obtained by the sensors 42a, 42b is used by the processor 48 to calculate the orientation of the object 44. The configuration of the sensors 42a and 42b may be used to detect the existence of the object in the inspection area as well as determining the initial disposition. The initial disposition of the object 44 is identified when both sensors 42a and 42b register a valid measurement in the Y direction.

Sensor 42c is aligned at a predetermined angle and a known predetermined coordinate to the X and Y axis to ensure measurement from a predetermined side 13 of the object 46. Sensor 42d is oriented to measure object 44 disposition in the Z direction. Therefore, sensor 42d is not disposed in a common plane with sensors 42a, 42b, and 42c, and is positioned at a higher elevation at a known position in the Z direction of the coordinate system. Therefore, sensor 42d senses spatial location of the object 44 in a vertical direction when the other sensors 42a, 42b, and 42c, sense spatial location of the object 44 in the horizontal direction.

The position of the object is estimated from the proposed sensor configuration as shown in FIGS. 4 and 5. Direction of motion of the object 44 is shown in FIG. 5 along arrow 50 so that sensor 42b registers measurement in the Y direction first. Sensor 42a also registers a measurement simultaneously identifying exact position of the object 44 relative to sensor 42a at a precise moment in time. A counter is included with the processor 48 to establish a time at which measurements are made. The measurement of sensor 42c at this time provides disposition of the object 44 in the X direction of the coordinate system. The measurement of sensor 42a gives disposition of the object 44 in the Y direction while sensor 42d gives disposition of the object 44 in the Z direction. At the same moment, the processor of 48 calculates distance between sensor 42a and sensor 42b and the difference between measurement of sensor 42a and sensor 42b orientation θ of the object is calculated using the formula θ=arctan (dy/b). Thus, orientation of the object at any given point in time within the coordinate system is determined from the location of the constructing points as measured by the sensors 42a and 42b.

As alluded to above, the processor 48 is programmed to calculate the time the object 44 takes to travel between sensor 42a and sensor 42b to determine average velocity of the object 44. Average velocity is calculated rather than relying on a single velocity measurement and is used to correct error in the measurement or any sensor latency. Using this approach, disposition of the object 44 represented by the datum 46 is calculated using the algorithm set forth in the processor. If the object 44 is a rigid body, the estimated disposition of the datum 46 within the common coordinate system is used to locate any component 52 disposed on the surface of the object 44 so that inspection of accurate location of the component 52 may be verified. It should be understood that once the datum 46 is located in the three-dimensional coordinate system the Computer Aided Design (CAD) data is accessed to verify accurate placement of the components 52 on the object 44. This is achieved through processor alignment of the calculated coordinate system with the coordinate system of the CAD data.

After calculating initial disposition of the object 44, continuous calculation using the proposed configuration of the sensors 42a,42b,42c,42d may be implemented. To achieve continuous calculation, sensor 42c is used to measure object disposition along the X direction pursuant to a continuous direct view of the leading portion of the edge 46 of the object 44 that is the identified corner 46 or datum as is represented in FIG. 5. Thus, the distance x is calculated along the X axis from the sensor 42c to a line extending to the datum 46 that is parallel to the Y axis. Sensors 42a and 42b provide measurements in the Y direction along with the θ orientation. Measurement of the θ orientation of the object 44 is calculated in the same manner as is the initial disposition of the object 44. The angle θ is the angle to from a line parallel to the Y axis and perpendicular to the X axis at the sensor 42a. Continuous measurement in the Y direction may be estimated from angle θ, distance Y¹, and Y², i.e., the distance measurements from sensors 42a and 42b shown in FIG. 5. The calculation may be performed by tracking the extrapolation of a line defined by edge 46 of the object until it intersects at the X axis. In a final measurement, sensor 42d provides a direct measurement of the object 44 in the Z direction. The same configuration may also be used to terminate inspection when the object 44 is no longer registering any measurements with sensors 42a and 42b meaning the object has passed through the inspection system 40.

The invention has been described in an illustrative manner; many modifications and variations of the present invention are possible, in light of the above teachings. It is therefore to be understood that within the specification, the reference numerals are merely for convenience, and are not to be in any way limiting, and that the invention may be practiced otherwise than is specifically described. Therefore, the invention can be practiced otherwise than is specifically described within the scope of the stated claims following this first disclosed embodiment.

What is claimed is:

1. A system for determining geometric disposition of an object within a coordinate system, comprising:
a processor;
a sensor array including a plurality of sensors oriented to scan a first edge and a second edge of an object thereby identifying a disposition of the first edge and the second edge within a coordinate system;
said sensor array being electronically connected to said processor for signaling the identified disposition of the first edge and the second edge of the object and said processor being programmed to calculate a location of an intersecting point of the first edge and the second edge; and
said processor calculating disposition of the object within the coordinate system from the calculated location of the of the intersecting point.

2. The system set forth in claim 1, wherein said sensor array includes a first arrangement of sensors located proximate the first edge of the object and a second arrangement of sensors located proximate the second edge of the object.

3. The system set forth in claim 2, wherein said sensors comprise at least one of a distance sensor, a proximity sensor, and a camera sensor.

4. The system set forth in claim 2, wherein said first arrangement of sensors include a first proximal sensor and a first distal sensor each identifying a constructing point on said first edge.

5. The system set forth in claim 2 wherein said second arrangement of sensors include a second proximal sensor and a second proximal sensor each identifying a constructing point on said second edge.

6. The system set forth in claim 1, wherein said sensor array includes a camera sensor disposed above the object for imaging an area of interest on the object.

7. The system set forth in claim 6, wherein said camera sensor identifies disposition of the first edge and the second edge of the object.

8. The system set forth in claim 2, wherein said sensor array defines the coordinate system and the object is located within the coordinate system defined by the sensor array.

9. The system set forth in claim 2, wherein said processor is programmed to correlate the detected location of the intersecting point of the first edge and the second edge to a datum located within the coordinate system.

10. The system set forth in claim 1, wherein said processor is programmed to correlate the datum with objects defined on the object.

11. The system set forth in claim 1, wherein said sensor array detects defined and dynamic movement of the object in the coordinates system from changes in disposition of the first edge and the second edge.

12. A method of identifying a disposition of an object within a coordinate system, comprising the steps of:
providing a sensor array and a processor for processing data received from the sensor array;
establishing a coordinate system defined by the sensor array;
placing the object within the coordinate system defined by the sensor array;
said sensor array detecting a plurality of constructing points on an edge of the object;
said processor identifying a datum of the object by extrapolating a line through the constructing points to said datum; and
said processor determining a disposition of the object within the coordinate system from identified location of said constructing points and said datum.

13. The method set forth in claim 12, wherein said step of said sensor array detecting a plurality of constructing points on an edge of the object is further defined by said sensor array detecting constructing points on a first edge and a second edge of the object.

14. The method set forth in claim 13, wherein said step of extrapolating a line through the constructing points is further defined by extrapolating a line through constructing points detected on said first edge and said second edge and identifying said datum by an intersecting point of the lines.

15. The method set forth in claim 12, wherein said sensor array comprises a first distance sensor and a second distance sensor disposed in a parallel orientation along a first axes of the coordinate system and said first sensor detects a first distance to a first constructing point and said second sensor detect a second distance to a second constructing point.

16. The method set forth in claim 15, further including a step of identifying motion of the object being inspected from said first sensor and said second sensor detecting changes in detected distance to the first and the second constructing points.

17. The method set forth in claim 12, wherein said sensor array comprises a camera and said camera detects the datum from an image of an edge a first edge and a second edge of the object.

18. The method set forth in claim 12, further a step of said sensor array identifying pixels from and image of the object.

19. The method set forth in claim 18, wherein said processor identify change of pixels between sequential images of the object thereby calculating movement of the object.

20. The method set forth in claim 12, wherein said step of identifying a coordinate system is further defined by identifying a three dimensional coordinate system.
